(19) United States
(12) Patent Application Publication
(10) Pub. No.: US 2007/0291763 A1
(43) Pub. Date: Dec. 20, 2007

(54) Ethernet® communication system relaying control signals

(75) Inventors: Hiroyuki Kaneko, Kawasaki (JP); Katsuhiko Nakamoto, Kawasaki (JP); Shotaro Ide, Kawasaki (JP); Osamu Tsurumi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/584,172

(22) Filed: Oct. 20, 2006

(30) Foreign Application Priority Data
Jun. 19, 2006 (JP) 2006-169100

(51) Int. Cl. H04L 12/28

(52) U.S. Cl. 370/395.5

(57) ABSTRACT

An Ethernet® communication system wherein control signals are relayed by ADM/WDM apparatuses and are directly transferred between L2/L3 switches apparatuses to enable application for new control protocols, improvement of the maintenance ability, etc., that is, an Ethernet® communication system provided with at least two transmission apparatuses arranged opposing each other across a transmission line at which an Ethernet® path is set and terminating units connected to the transmission apparatuses and communicating between terminating units through said transmission apparatuses, wherein each of the transmission apparatuses is provided with a relaying means for relaying communications by insertion of control signals transferred by interfaces of the terminating units, without termination at the transmission apparatus, into Ethernet® frames between the transmission apparatuses, and the control signals are passed through the relaying means to the opposing side terminating unit.

### BACKGROUND OF THE INVENTION

1. Field of the Invention

The present invention relates to an Ethernet® communication system enabling the transfer of control signals between terminating unit connected to one transmission apparatus and terminating unit connected to an opposing transmission apparatus.

2. Description of the Related Art

In general, in the infrastructure facilities of the telecommunication carriers, L2/L3 switches (Layer 2 or Layer 3 switches) are connected as client nodes (terminating units) of SONET/SDH ADM (Add/Drop Multiplex) apparatuses or WDM (Wavelength Division Multiplex) apparatuses (transmission apparatuses). There is a Gigabit Ethernet® communication system laying GbE (Gigabit Ethernet®) paths between these L2/L3 switches.

Below, the drawings will be used to explain a conventional Gigabit Ethernet® communication system. Throughout the drawings, the same reference numerals indicate the same components.

FIG. 1 is a block diagram showing the general configuration of a conventional Gigabit Ethernet® communication system in the case of use of transmission apparatuses comprised only of WDM apparatuses. In the figure, 11 and 12 indicate WDM apparatuses for multiplexing and transmitting a plurality of optical signals of wavelengths λ₁ to λ_{N}, 100 to 10(N-1) indicate #0-th to #(N-1)-th terminating units constituted by L2/L3 switches (Layer 2 switches or Layer 3 switches) connected to the WDM apparatus 11, and 110 to 11(N-1) indicate #0-th and #(N-1)-th terminating units constituted by L2/L3 switches connected to the WDM apparatus 12. N (N is a positive integer) number of terminating units are connected to each transmission apparatus. In general, the distance between the WDM apparatuses 11 and 12 is long, for example, a distance between Tokyo and Osaka.

FIG. 2 is a block diagram showing the general configuration of a conventional Gigabit Ethernet® communication system in the case of use of transmission apparatuses comprised only of SONET/SDH ADM apparatuses. In the figure, 21 and 22 are ADM apparatuses for transmitting for example 10 Gigabit optical signals. These ADM apparatuses have terminating units 100 to 10(N-1) and 110 to 11(N-1) similar to FIG. 1 connected to them. In general, the distance between the ADM apparatuses 21 and 22 is long, for example, the distance between Tokyo and Osaka.

FIG. 3 is a showing the general configuration of a communication system mixing the systems of FIG. 1 and FIG. 2. In the figure, 31 and 32 indicate WDM apparatuses, while 33, 34, 35, and 36 indicate ADM apparatuses. The ADM apparatus 33 has the terminating units 100 to 10(N-1) connected to it, while the ADM apparatus 36 has the terminating units 110 to 11(N-1) connected to it. The ADM apparatus 34 and the WDM apparatus 31 are connected by N number of lines, while the ADM apparatus 35 and the WDM apparatus 36 are connected by N number of lines. The ADM apparatuses transmit 10 Gigabit optical signals between them, while the WDM apparatuses transmit wavelength λ₁ to λ_{N} optical signals between them in a multiplexed format. In general, the distance between the ADM apparatuses 33 and 34, the distance between the WDM apparatuses 31 and 32, and the distance between the ADM apparatuses 35 and 36 is long, for example, for example, Tokyo and Nagoya, Nagoya and Osaka, and Osaka and Fukuoka.

FIG. 4 is a block diagram showing details of the Gigabit Ethernet® communication system in the case of use of only the WDM apparatuses shown in FIG. 1. In the figure, the WDM apparatus 11 is for example, a GbE (Gigabit Ethernet®) multiplex transponder board provided with processors 400 to 407 for PHY (Physical Layer) processing and MAC (Media Access Control) processing, a GFP framer 408 for GFP (Generic Framing Protocol) processing, a OC192 framer 409 for OC192 processing, a digital wrapper LSI 410 for mapping to the OC192 frame, and a PMD (Physical Media Dependent) 411 forming a DM port. The opposing WDM apparatus 12 is configured the same as the WDM apparatus 11, and the same components are assigned the same reference numerals with apostrophes.

The WDM port is for example a 10.7 Gbps (Gigabit per second) OTN (Optical Transport Network). Each of the processors 400 to 407 is provided with physical layers PMD (Physical Medium Depending), PMA (Physical Medium Attachment), and PCS (Physical Coding Sub-layer). Specifications of these PMD, PMA, and PCS layers are defined by the IEEE (Institute of Electrical and Electronics Engineers).

The GFP framer 408 and the processors 400 to 407 transmit for example 8 B (byte) data between them at a 1 Gbps transmission rate. The GFP framer 408 and OC192 framer 409 and the digital wrapper transfer data at a 10 Gbps transmission rate. The WDM transmission line between the WDM apparatuses 11 and 12 carries the wavelength λ₁ to λ_{N} optical signals between them in a multiplexed format at 10.7 Gbps.

The terminating unit constituted by the L2/L3 switch 100 and the processor 400 auto negotiate by transferring 1.25 Gb auto negotiation signals. Similarly, at the opposing side as well, the terminating unit constituted by the L2/L3 switch 111 and the processor 400′ auto negotiate by transferring 1.25 Gb auto negotiation signals. The other terminating units and processors also transfer auto negotiation signals.

Next, the operation of the system of FIG. 4 will be explained. First, Gigabit Ether (GbE) signals from the L2/L3 switches 100 to 107 are received by the processors 400 to 407 in the WDM apparatus 11, then the processors 400 to 407 perform PHY processing and MAC processing on the GbE signals. Afterwards, the GbE signals are mapped on a GFP frames by a GFP framer 408, are mapped on OTN (Optical Transport Network) frames for FEC (error correction) processing by the digital wrapper LSI 411 (digital wrapper processing), and are converted to WDM optical signals. At the opposing side WDM apparatus 12, an operation reverse to the operation at the WDM apparatus 11 is performed for the transmission of data to the terminating unit constituted by the L2/L3 switch 111.

In the prior art, Layer 1 signals such as auto negotiation signals sent from the terminating units constituted by the L2/L3 switches 100 to 107 toward the processors 400 to 407 are terminated at the processors 400 to 407. That is, the auto negotiation signals sent by the terminating units constituted by the L2/L3 switches are used only when linking with the WDM apparatus 11 and end up being discarded at the MAC processing. That is, the Layer 1 signals such as the auto negotiation signals are transferred between the L2/L3 switches apparatuses 100 to 107 and the processors 400 to 407 and are utilized only for link connection negotiations in these sections.

FIG. 5 is a block diagram showing in detail the configuration of a Gigabit Ethernet® communication system in the case of using only SONET/SDH ADM apparatuses such as shown in FIG. 2. In the figure, the ADM apparatus 21 is for example a node provided with a low speed IF (interface) board 501, cross connect board 502, and high speed IF (interface) board 503. The opposing ADM apparatus 22 is configured the same as the ADM apparatus 21, and the same components are assigned the same reference numerals with apostrophes.

Between the high speed IF boards 503 and 503′ is provided a transmission line using TDM (time division multiplexing), for example, a 2.4 Gbps SONET interface OC-48 or 10 Gbps SONET interface OC-192. The low speed IF board 501 is provided with processor 510 to 517 each of which is provided with physical layers PHY (Physical Layer), MAC (Media Access Control), PHY (Physical Layer), and VC (Virtual Container). The specifications for these PHY, MAC, PHY, and VC layers are established by the ITU (International Telecommunications Union).

Next, the operation of the system shown in FIG. 5 will be explained. In the conventional ADM apparatus 21, GbE signals from the terminating units L2/L3 switches 100 to 107 are received at the low speed IF board 501. The low speed IF board 501 first performs PHY processing, MAC processing, and VC processing on the GbE signals. After this, the VC signals are processed at the cross connect board 502 for cross connection and are transmitted through the high speed IF board 503 to the TDM transmission line. In this case as well, Layer 1 signals such as auto negotiation signals are transferred between the L2/L3 switches 100 to 107 and the low speed IF board 501 and are utilized only for link connection negotiation of this section.

As technology enabling auto negotiation between terminals, the one described in Japanese Patent Publication (A) No. 2004-357164 is known. According to this Japanese Patent Publication (A) No. 2004-357164, a Gigabit Ethernet® signal with input processing units of 10 bits is decoded by 8 B/10 B decoding to convert it into a Gigabit Ethernet® signal with processing units of 8 bits and generate packet data, the auto negotiation information included in the Gigabit Ethernet® signal with processing units of 10 bits is extracted to generate a control data frame signal, the packet data is read out in accordance with preassigned time slots and time division multiplexed on the payload of the SDH signal, and the control data frame signal is inserted into the overhead and transmitted to thereby enable auto negotiation between terminals.

In the prior art shown in FIG. 4, Layer 1 signals such as auto negotiation signals sent from the terminating units constituted by the L2/L3 switches 100 to 107 to the processors 400 to 407 are terminated at the processors 400 to 407. Further, in the prior art shown in FIG. 5, Layer 1 signals such as auto negotiation signals sent from the L2/L3 switches 100 to 107 to the low speed IF board 501 are terminated at the low speed IF board 501. In each case, the auto negotiation signal ends up being discarded by the MAC processing.

However, Layer 1 signals such as auto negotiation signals originally should be transferred between the terminating units constituted by the L2/L3 switches 100 to 107 and the opposing side terminating units constituted by the L2/L3 switches 110 to 117. The processors 400 to 407 in the system of FIG. 4 and the processors 510 to 517 in the system of FIG. 5 are not necessary for termination.

Further, the art described in Japanese Patent Publication (A) No. 2004-357164 enables auto negotiation between terminals, but the auto negotiation signals have to be inserted into the overheads of the SDH signals. For this reason, the fundamental parts of the WDM apparatuses and ADM apparatuses for performing the multiplexing and demultiplexing have to be modified. This modification requires that the entire system be temporarily shut down and changed to enable insertion of the auto negotiation signals into the payloads or requires the entire chips of the fundamental parts to be replaced, so realization is difficult.

### SUMMARY OF THE INVENTION

An object of the present invention is to provide an Ethernet® communication system which enables Layer 1 signals such as auto negotiation signals and other control signals to be relayed by the ADM/WDM apparatuses and directly transferred between L2/L3 switches without modifying the fundamental parts of the ADM/WDM apparatuses and thereby enables application for new control protocols, improvement of the maintenance ability, etc.

To achieve this object, according to the present invention, there is provided an Ethernet® communication system comprising at least two transmission apparatuses arranged opposing each other across a transmission line at which an Ethernet® path is set and terminating units connected to the transmission apparatuses respectively and communicating between the terminating units through the transmission apparatuses, wherein each of the transmission apparatuses comprises a relaying means relaying by insertion of control signals transferred by interfaces of the terminating units, without termination at the transmission apparatuses, into Ethernet® frames between the transmission apparatuses, and the control signals are passed through the relaying means to the opposing side terminating unit.

Preferably, the relaying means enables flow control by allowing the relaying of pause signals.

Alternatively, the relaying means relays only the signals necessary for auto negotiation among the terminating units among the control signals.

Alternatively, each transmission apparatus is a multiplex transponder board having a plurality of low speed side interfaces with the terminating units and a single high speed side network interface with the opposing transmission apparatus and multiplexing and demultiplexing data between the transmission apparatuses, maps port numbers of terminating units at undefined areas of an order set in the control signal, and, during transferring of control signals with the opposing transmission apparatus, converts undefined areas of the order set to VLAN ID so as to set paths between one of the terminating units and any one of the terminating units of the opposing transmission apparatus using Ethernet® frames.

Alternatively, the control signals are signals defined by terminating units notifying an opposing terminating units of the quality and state of a link between the terminating units after being established.

More preferably, the terminating units are Layer 3 switches, the defined control signals include the maximum transfer frame lengths, and the smaller of the maximum transfer frame lengths as a result of negotiation between the Layer 3 switches is set as the maximum transfer frame length between the Layer 3 switches.

Alternatively, port identification numbers are inserted into VLAN tags of the Ethernet® frame.

Conventional auto negotiation signals were terminated at transmission apparatuses by MAC processing, so only the states of the links between the terminating unit and the transmission apparatus (sections) were known. However, in the present invention, the auto negotiation signals are made to be directly transferred between terminating equipment, so when directly negotiating for connection with the opposing terminating unit, the maintenance personnel need only check the state of the link of the terminating units (visually) in order to easily learn the state of the link in the path section up to the opposing terminating unit positioned across the transmission apparatus and therefore there is the effect that the maintenance ability is improved.

Further, by inserting the control signals in the payloads of the Ethernet® frames before multiplexing and inserting the port identification numbers showing the destinations into the headers of the Ethernet® frames in the relaying operation, it becomes possible for control signals to be simply transferred between terminals of opposing apparatuses without changing the fundamental parts of the transmission apparatuses.

Further, when as a result of the negotiations for connection between opposing terminating units, the flow control function is made valid, pause signals have to be passed through the transmission apparatus. In conventional Layer 2 processing according to the IEEE, the rule is that pause signals not be relayed, but relaying of the pause signals is allowed just for this application according to the present invention so as to enable direct flow control between terminating units.

Further, by relaying only the signals required for auto negotiation among terminating units in the control signals, applications for redundant protocol such as switching routes among terminating units may be considered.

Further, by using the control signals to inform the terminating units constituted by the Layer 3 switches of each other's maximum transfer frame length, applications where the smaller value as a result of negotiations is set as the maximum transfer frame length of the two Layer 3 switches may be considered.

### BRIEF DESCRIPTION OF THE DRAWINGS

The present invention may be more fully understood from the description of the preferred embodiments of the invention set forth below together with the accompanying drawings, in which

FIG. 1 is a block diagram showing the general configuration of a conventional Gigabit Ethernet® communication system in the case of use of transmission apparatuses of only WDM apparatuses;

FIG. 2 is a block diagram showing the general configuration of a conventional Gigabit Ethernet® communication system in the case of use of transmission apparatuses of only SONET/SDH ADM apparatuses;

FIG. 3 is a block diagram showing the general configuration of a communication system mixing the systems of FIG. 1 and FIG. 2;

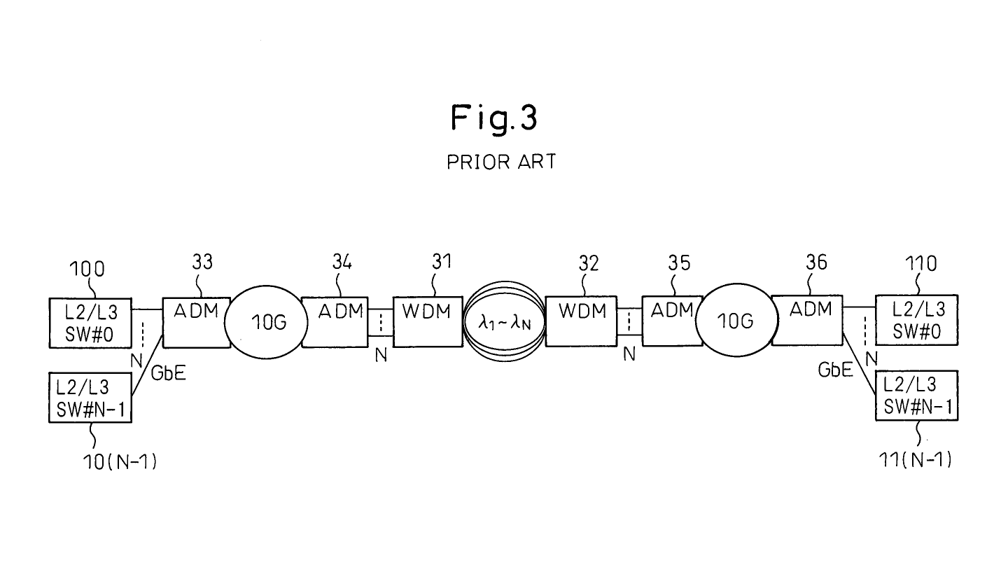

FIG. 4 is a block diagram showing the general configuration of a conventional Gigabit Ethernet® communication system in the case of use of only the WDM apparatuses shown in FIG. 1;

FIG. 5 is a block diagram showing the general configuration of a conventional Gigabit Ethernet® communication system in the case of use of only the SONET/SDH ADM apparatuses shown in FIG. 2;

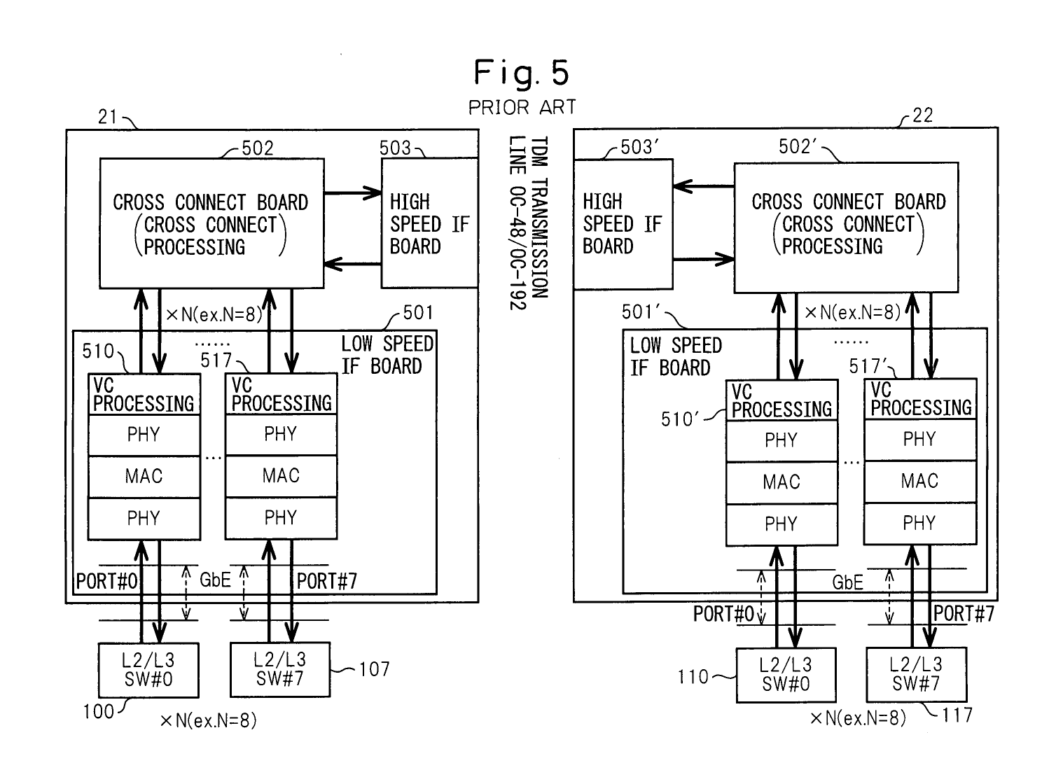

FIG. 6 is a block diagram showing in detail the configuration of a Gigabit Ethernet® communication system in the case of use of only WDM apparatuses shown in FIG. 1 according to a first embodiment of the present invention;

FIG. 7 is a block diagram showing in detail the configuration of a Gigabit Ethernet® communication system in the case of use of only SONET/SDH ADM apparatuses shown in FIG. 2 according to a second embodiment of the present invention;

FIG. 8A is a view of an example of an auto negotiation 8B signal;

FIG. 8B is a view of the signal format of an Ethernet® MAC frame; and

FIG. 9 is a block diagram showing the general configuration of a communication system mixing the systems of FIG. 6 and FIG. 7 according to a third embodiment of the present invention.

### DESCRIPTION OF THE PREFERRED EMBODIMENTS

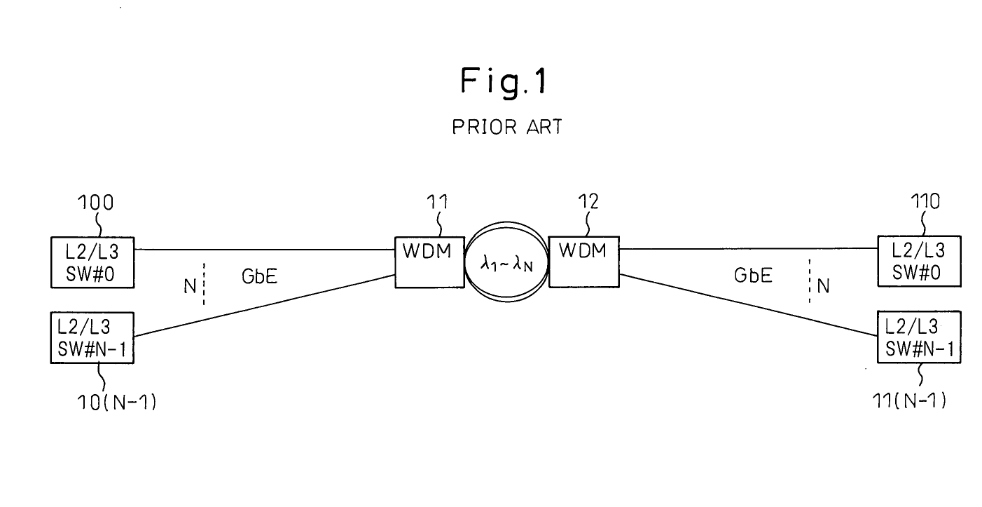

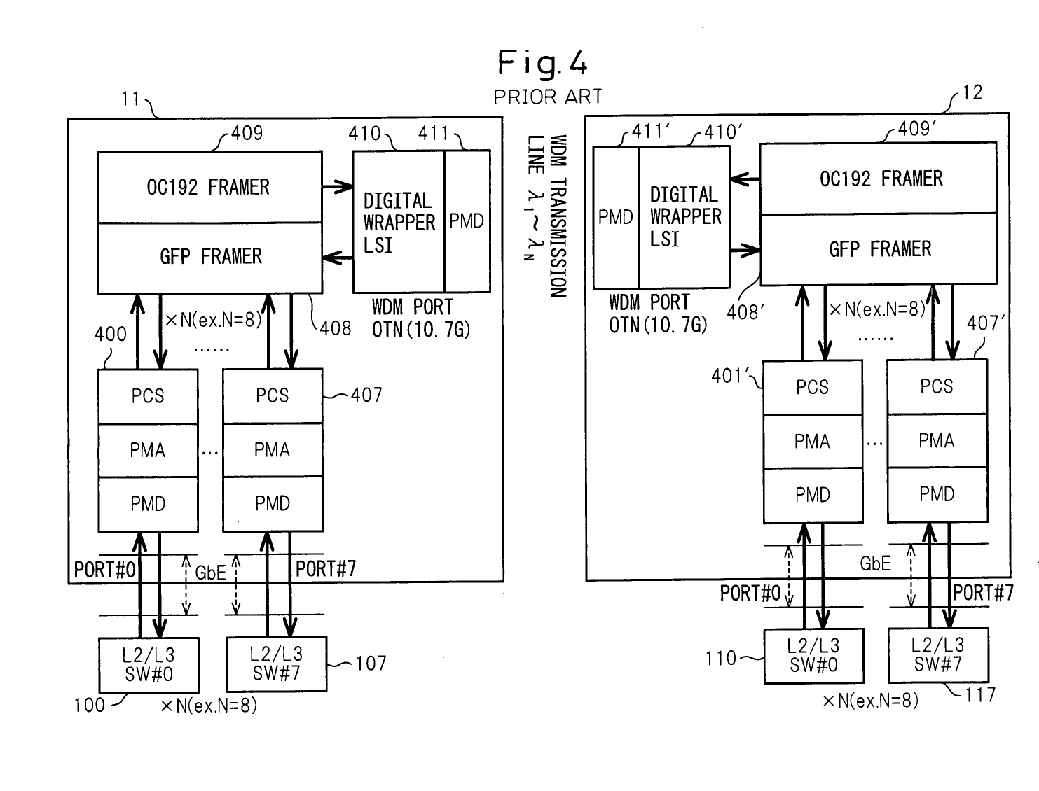

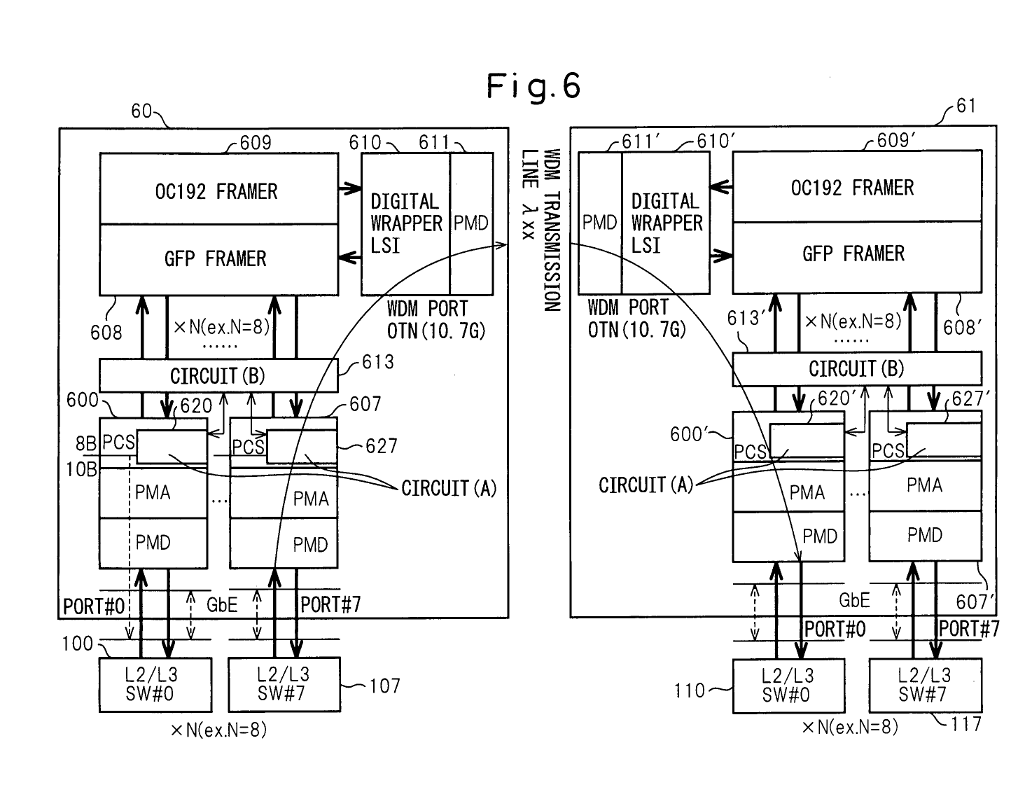

FIG. 6 is a block diagram showing in detail the configuration of a Gigabit Ethernet® communication system in the case of use of only the WDM apparatuses shown in FIG. 1 according to a first embodiment of the present invention. In the figure, the WDM apparatus 60 is, for example, a GbE (Gigabit Ethernet®) multiplex transponder board provided with processors 600 to 607 for performing PHY (Physical Layer) processing and MAC (Media Access Control) processing, a GFP framer 608 for performing GFP (Generic Framing Protocol) processing, an OC192 framer 409 for performing OC192 processing, a digital wrapper LSI 610 for mapping on the OC192 frames, and a PMD (Physical Media Dependent) 611 serving as the WDM port. The opposing WDM apparatus 61 is configured the same as the WDM apparatus 60, and the same components are assigned the same reference numerals. The configuration up to here is the same as the conventional WDM Gigabit Ethernet® communication system shown in FIG. 4.

According to this embodiment of the present invention, the processors 600 to 607 are provided with circuits (A) 620 to 627 for identifying auto negotiation signals sent from the terminating units 100 to 107 and 110 to 117 based on the K28.5 and the control code (0xB5/0x42, that is, hexadecimal B5 or 42). The processors 600 to 607 and the GFP framer 608 are connected by the circuit (B) 613. The circuit (B) 613 matches the port number of the terminating units (0≦port ID≦N-1) (N is 8 in this embodiment) with the VLAN ID of the Ethernet® frame and inserts this as an Ethernet® signal in the header of the Ethernet® frame or, if detecting an Ethernet® frame showing an auto negotiation signal, judges the destination port identification number from the VLAN ID, generates an auto negotiation signal, and inserts the auto negotiation signal at the inserted port shown by the reserved area. The opposing WDM apparatus 61 is also provided with the same circuits (A) 620′ to 627′ and circuits (B) 613′. The circuits (A) 620′ to 627′, circuits (B) 613′, circuits (A) 620′ to 627′, and circuit (B) 613′ form the relaying means for relaying the control signals.

The WDM port is for example a 10.7 Gbps (Gigabit per second) OTN (Optical Transport Network). Each of the processors 600 to 607 is provided with physical layers PMD (Physical Medium Depending), PMA (Physical Medium Attachment), and PCS (Physical Coding Sub-layer). The specifications of these PMD, PMA, and PCS are determined by the ITU (International Telecommunications Union).

Between the GFP framer 608 and the processors 600 to 607, 8 B (byte) data is transmitted at for example a 1 Gbps transmission rate. The GFP framer 608 and OC192 framer 609 and the digital wrapper transfer data at a 10 Gbps transmission rate. The WDM transmission line between the WDM apparatuses 60 and 61 carries the multiplexed wavelength λ₁ to λ_{N} optical signals at 10.7 Gbps.

Next, the operation of the system shown in FIG. 6 will be explained. The WDM apparatus 60 receives Gigabit Ether (GbE) signals from the terminating units constituted by the L2/L3 switches 100 to 107 at the processors 600 to 607 in the WDM apparatus 60 and processes the GbE signals at the processors 600 to 607 by PHY processing and MAC processing. Next, when any of the circuit units (A) 620 to 627 in the process of 8 B/10 B code conversion at the PHY processing (PCS unit) receives the auto negotiation signal based on the special code K28.5 and control code (0xB5/0x42), the received port identification number of the port (PortID) is transferred to the circuit unit (B) 613. The “port identification number” shows a value set in common with the GbE port of the WDM apparatus when setting the GbE path between WDM nodes (0≦PortID≦N-1). The circuit unit (B) 613 generates Ethernet® frames including the auto negotiation signal in the payload and including the port identification number showing the destination in the header and inserts it in the GFP frame. The Ethernet® frames are identified by the ether type value locally determined in the apparatus. This ether type value is preferably structured to be able to be set and changed by external operation. After this, the Ethernet® frames are generally processed to be inserted into the GFP frame and mapped by the OC-192 framer 609 onto the OC-192 frame. Further, for FEC (error correction) processing, they are sometimes also mapped onto the OTN (Optical Transport Network) frames (digital wrapper processing), converted to WDM optical signals, and sent over the transmission line.

The WDM optical signal received by the opposing side WDM apparatus 61 is broken down into Ethernet® frames by the processing up to the GFP framer 608′. When the circuit unit (B) 613′ detects an Ethernet® frame suggesting an auto negotiation signal, it judges the destination port identification number from the VLAN ID included in its header and inserts the auto negotiation signal (8 B) into the port. The auto negotiation signal (8 B) is converted to a 10 B code by usual PHY processing and reaches the destination terminating units constituted by the L2/L3 switches 110 to 117.

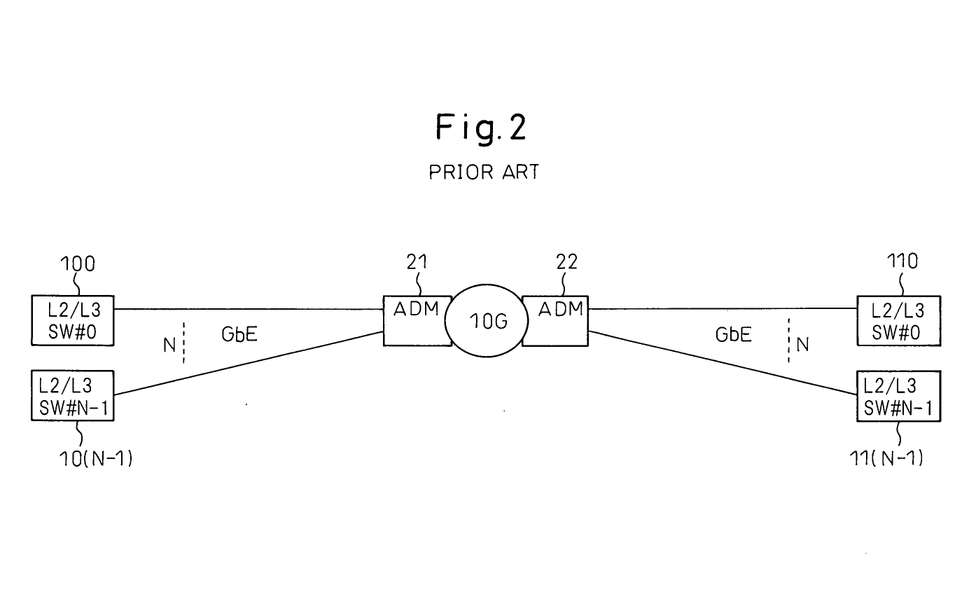

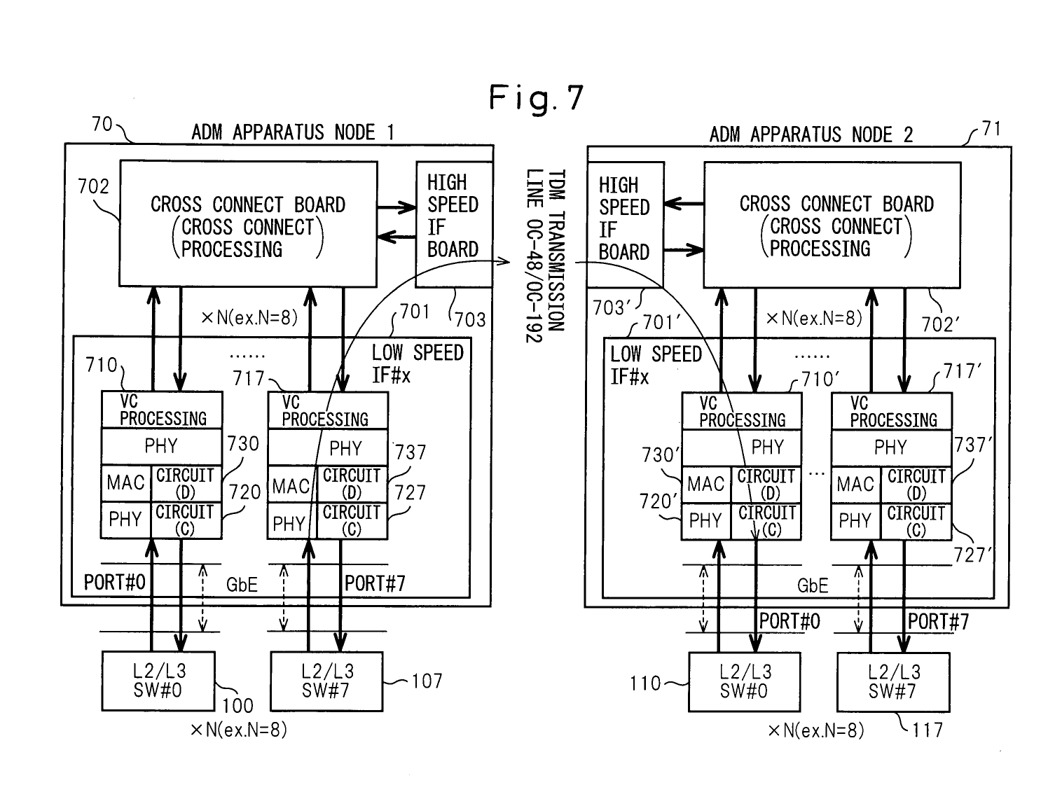

FIG. 7 is a block diagram showing in detail the configuration of a Gigabit Ethernet® communication system in the case of use of only the SONET/SDH ADM apparatuses shown in FIG. 2 according to the second embodiment of the present invention. In the figure, the ADM apparatus 70 is, for example, a node provided with a low speed IF (interface) board 701, cross connect board 702, and high speed IF (interface) board 703. The opposing ADM apparatus 71 is configured the same as the ADM 701, and the same components are assigned the same reference numerals.

Between the high speed IF boards 703 and 703′ is a TDM (time division multiplexing) transmission line such as a 2.4 Gb SONET OC-48 or 10 Gb SONET OC-192. The low speed IF board 501 is provided with processors 510 to 517, each of which is provided with the physical layers PHY (Physical Layer), MAC (Media Access Control), PHY (Physical Layer), and VC (Virtual Container). The specifications of these PHY, MAC, PHY, and VC are defined by the ITU (International Telecommunications Union).

According to this embodiment of the present invention, the processors 710 to 717 are provided with circuits (C) 720 to 727 for identifying auto negotiation signals sent from the terminating units 100 to 107 from the K28.5 and control code (0xB5/0x42) and circuits (D) 730 to 737 for inserting Ethernet® frames showing the auto negotiation signals into the transmission signals. The opposing ADM apparatus 71 is also provided with circuits (D) 730′ to 737′ for detecting Ethernet® frames showing auto negotiation signals from the received signals and generating an auto negotiation signal with 1 byte consisting of 8 B (bits) and circuits (C) 720′ to 727′ for converting the 8B signal into auto negotiation signals with 1 byte consisting of 10 B (bits). The circuits (C) 720 to 727, circuits (D) 730 to 737, circuits (D) 730′ to 737′, and circuits (C) 720′ to 727′ form the relaying means for relaying the control signals.

Next, the operation of the system shown in FIG. 7 will be explained. The ADM apparatus 70 receives the Gigabit Ether (GbE) signals from the terminating units constituted by the L2/L3 switches 100 to 107 at the low speed IF board 701. At the low speed IF board 701, first the GbE signals are processed by PHY processing and MAC processing. In the process of 8 B/10 B code conversion at the PHY processing (PCS unit), when the circuits (C) 720 to 727 receive the auto negotiation signals based on the judgment by the special code K28.5 and control code (0xB5/0x42), they generate Ethernet® frames incorporating the auto negotiation signals in the payloads and port identification numbers showing the destination in the headers, then perform VC processing to convert them to TDM signals. The Ethernet® frames, in the same way as the case of the WDM apparatus 60 shown in FIG. 6, are identified by the ether type value locally determined in the apparatus. This ether type value is preferably structured to be able to be set and changed by external operation. After this, the VC processed Ethernet® frames are multiplexed on the high speed TDM signals (for example, OC-48 or OC-192) by the cross connect board and sent through the high speed IF board 703 to a transmission line. The TDM signal received at the opposing side ADM apparatus 71 is broken down into @Ethernet® frames up to the VC processing. When the circuits (D) 730′ to 737′ detect an Ethernet® frame suggesting an auto negotiation signal, the auto negotiation signal (8 B) is inserted into the ports. The auto negotiation signal (8 B) is converted to a 10 B code by the usual PHY processing and reaches the destination terminating units constituted by the L2/L3 switches 110 to 117.

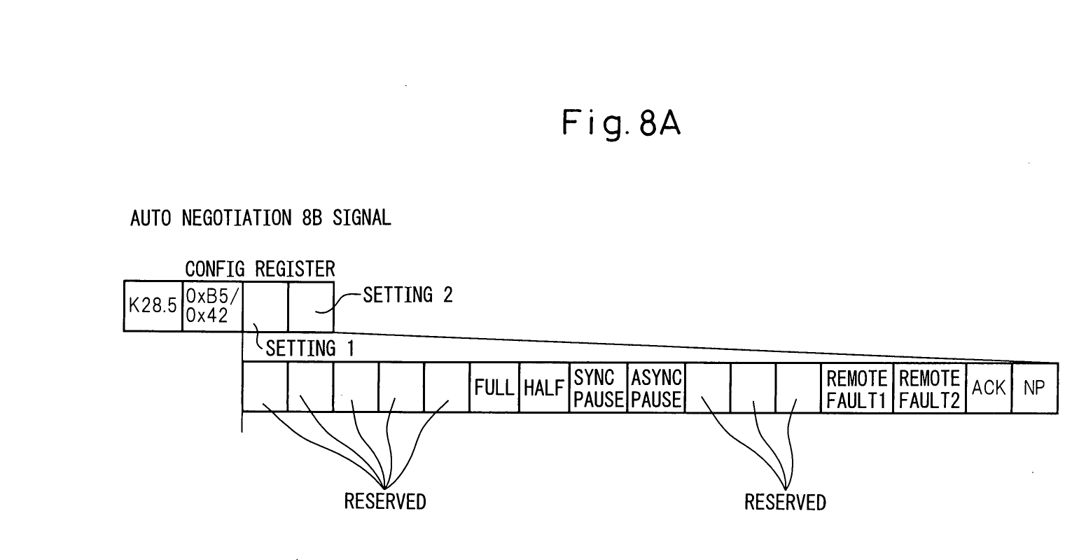

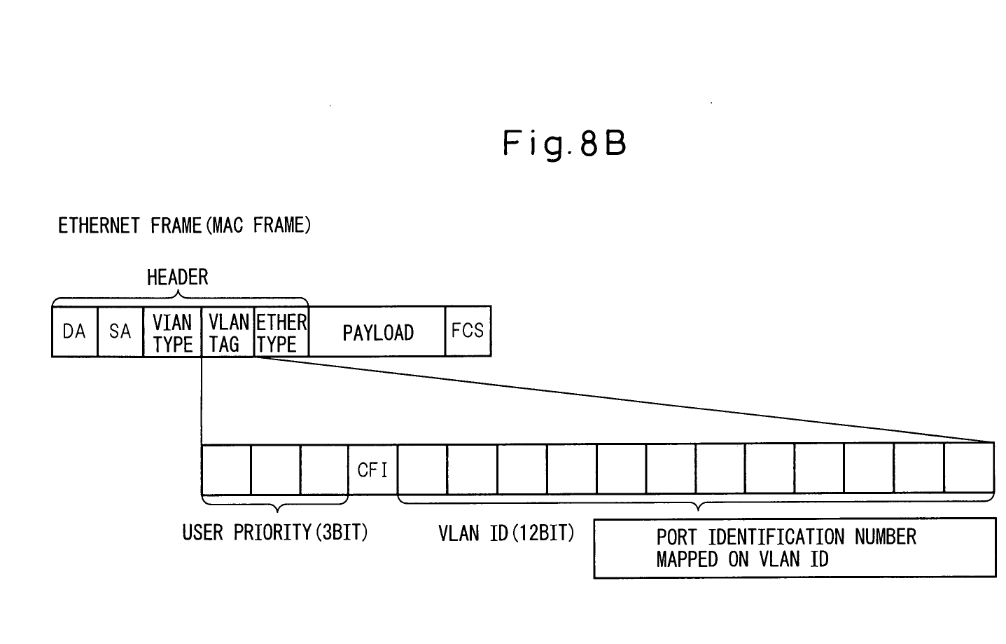

FIG. 8A is a view showing an example of an auto negotiation signal, and FIG. 8B is a view showing the signal format of an Ethernet® MAC frame. As shown in FIG. 8A, the auto negotiation signal includes a special code K28.5 and its following control code 0xB5/0x42. These are identified and detected by the circuits (A) 620 to 627 in the system of FIG. 6 or the circuits (C) 720 to 727 of the system of FIG. 7. Further, as shown in FIG. 8B, a port identification number is mapped in the VLAN ID inside the header at a part other than the payload of the Ethernet® MAC frame and the destination port information is sent to the opposing WDM apparatus.

When as a result of the negotiations for connection between opposing terminating units constituted by the L2/L3 switches 110 to 117, the flow control function is made valid, pause signals (DA:0x0180c2000001) have to be passed through the WDM/ADM apparatuses. In conventional MAC processing of the IEEE, the rule is that the pause signals not be relayed, but in the first and second embodiments of the present invention, relaying of the pause signal is allowed in the MAC processing of the WDM/ADM apparatuses so as to enable direct flow control between opposing L2/L3 switches.

By defining a new value for the data code following the special code (K28.5) (in the auto negotiation, 0xB5/0x42) and, after the link between the opposing terminating units (L2/L3 switches) is established, notifying the quality information of the transmission line (line disconnection etc.) by the “disconnection notification control signal” to the opposing terminating unit (L2/L3 switch), application for redundancy protocol for switching routes between terminating units (L2/L3 switches) becomes possible.

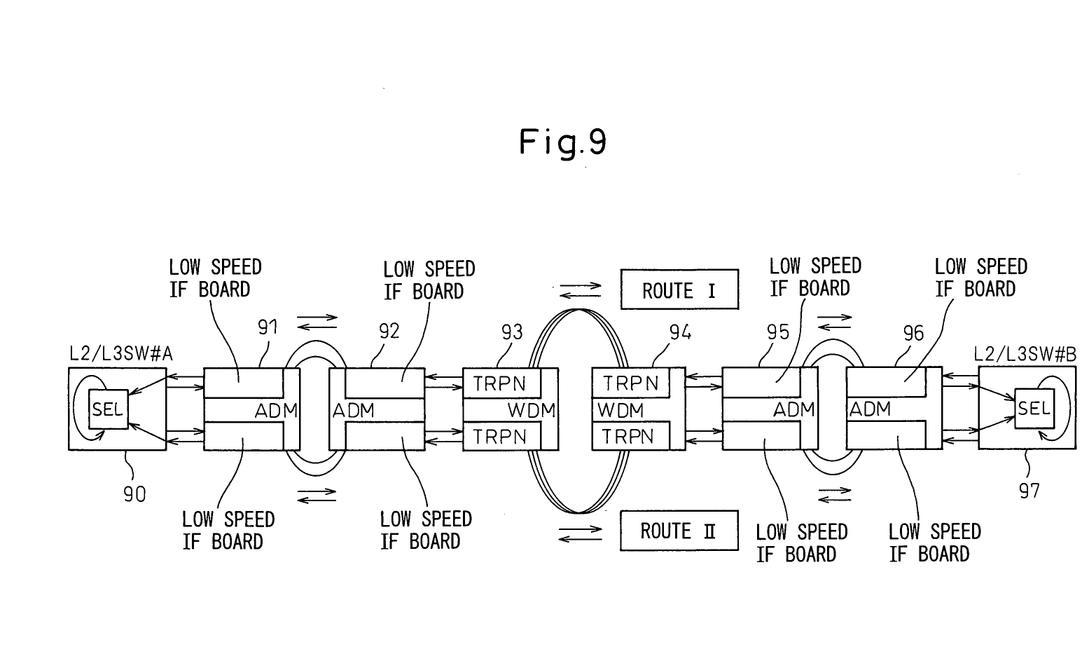

FIG. 9 is a block diagram showing the general configuration of a communication system mixing the systems of FIG. 6 and FIG. 7 according to a third embodiment of the present invention. In the figure, 90 indicates a terminating unit (L2/L3 switch #A) provided with a selector SEL, 91 an ADM apparatus provided with a low speed IF board for interfacing with the terminating unit, 92 an ADM apparatus provided with a low speed IF board for interfacing with an WDM apparatus 93, 93 a WDM apparatus provided with a transponder board (TRPN) for communicating with the low speed IF board of the ADM apparatus, 94 an opposing side WDM apparatus, 95 an ADM apparatus connected to the WDM apparatus 94, 96 an ADM connected to the ADM 95, and 97 an opposing side terminating unit (L2/L3 switch #B).

Next, the operation of the system shown in FIG. 9 will be explained. Consider the case when opposing L2/L3 switches communicate over a WDM/ADM apparatus section by a preliminarily open path and the L2/L3 switches #A and #B at the two ends select data of the route I side.

First, when a fault occurs in the section of the transmission line between the ADM apparatuses 95 and 96, the loss of the optical signal (LOS) is detected by the input of the terminating unit (L2/L3 switch #B) 97.

This being the case, the terminating unit (L2/L3 switch #B) 97 switches the selection system at the SEL unit in the terminating unit (L2/L3 switch #B) from the route I to the route II due to the loss of the optical signal.

Next, the terminating unit (L2/L3 switch #B) 97 transmits a disconnection notification control signal toward the opposing side terminating unit (L2/L3 switch #A) 90, and the opposing side terminating unit (L2/L3 switch #A) 90 receives this disconnection notification control signal.

Next, the selection system of the SEL unit of the terminating unit (L2/L3 switch #A) 90 is switched from the route I to the route II.

In the above way, a redundancy protocol enable switching control by transferring disconnection notification control signals even if a fault occurs in a section of the transmission line is loaded in the terminating units (L2/L3 switches). The disconnection notification control signals are differentiated from other control signals by defining a new value in the area (1 byte) after K28.5.

Further, by newly defining a separate control signal (MTU notification control signal), it becomes possible to notify the L3 switches of each other's MTU (maximum transfer frame length). Applications may be considered in which the smaller of the values as a result of this negotiation is set as the MTU value for both terminating units (L3 switches). The MTU information is embedded in the Config register area for transferring of information. This MTU notification control signal is differentiated from other control signals by defining a new value in the area (byte) following K28.5.

In the above embodiments, eight terminating units were illustrated, but the present invention is not limited to this. Any number is possible. Further, the communication system was illustrated as a Gigabit Ethernet®, but the present invention is not limited to this and can be applied to any communication rate Ethernet®.

According to the present invention, opposing terminating units (L2/L3 switches) can transfer control signals and therefore the following applications can be realized. That is, when the WDM/ADM apparatuses relay auto negotiation signals and the opposing terminating units (L2/L3 switches) directly negotiate for connection with each other, the maintenance personnel can determine the state of the link up to the opposing apparatus a long distance away without modifying the fundamental parts of the WDM/ADM apparatuses, so the maintenance ability is greatly improved. Further, when as a result of the negotiation for connecting between opposing terminating units (L2/L3 switches), the flow control function is made valid, pause signals have to be passed through the MAC processing of the WDM/ADM apparatuses. In terms of this application, by allowing the pause signals to be relayed, direct flow control between the L2/L3 switches becomes possible.

Further, by defining a new value in the data code following a special code (K28.5) and notifying the quality and state of the transmission line (disconnection of optical signal line etc.) to the opposing terminating unit (L2/L3 switch), it is possible to realize redundancy protocol for switching routes between terminating units (L2/L3 switches).

Further, by using the control signals to notify the Layer 3 terminating units (L3 switches) of each other's MTU (maximum transfer frame length), it is possible to realize applications where the smaller of the values as a result of negotiations is set as the MTU value of both terminating units (L3 switches).

While the invention has been described by reference to specific embodiments chosen for the purposes of illustration, it should be apparent that numerous modifications could be made thereto by those skilled in the art without departing from the basic concept and scope of the invention.

1. An Ethernet® communication system comprising:
at least two transmission apparatuses arranged opposing each other across a transmission line at which an Ethernet® path is set; and terminating units connected to said transmission apparatuses respectively and communicating between said terminating units through said transmission apparatuses, wherein each of said transmission apparatuses comprises a relaying means relaying communications by insertion of control signals transferred by interfaces of said terminating units, without termination at said transmission apparatuses, into Ethernet® frames between said transmission apparatuses, said control signals being passed through said relaying means to the opposing side terminating unit.

2. An Ethernet® communication system as set forth in claim 1, wherein said relaying means enables flow control by allowing the relaying of pause signals.

3. An Ethernet® communication system as set forth in claim 1, wherein said relaying means relays only the signals necessary for auto negotiation among the terminating units among the control signals.

4. An Ethernet® communication system as set forth in claim 1, wherein each transmission apparatus is a multiplex transponder board having a plurality of low speed side interfaces with said terminating units and a single high speed side network interface with the opposing transmission apparatus and multiplexing and demultiplexing data between said transmission apparatuses, maps port numbers of said terminating units at undefined areas of an order set in said control signal, and, during transferring of said control signals with the opposing transmission apparatus, converts undefined areas of the order set to VLAN ID so as to set paths between one of said terminating units and any one of said terminating units of the opposing transmission apparatus using Ethernet® frames.

5. An Ethernet® communication system as set forth in claim 1, wherein the control signals are signals defined by said terminating units notifying the opposing terminating unit of the quality and state of a link between the terminating units after being established.

6. An Ethernet® communication system as set forth in claim 5, wherein the terminating units are Layer 3 switches, the defined control signals include the maximum transfer frame lengths, and the smaller of the maximum transfer frame lengths as a result of negotiation between the Layer 3 switches is set as the maximum transfer frame length between the Layer 3 switches.

7. An Ethernet® communication system as set forth in claim 1, wherein port identification numbers are inserted into VLAN tags of said Ethernet® frame.
